(19) United States
(12) Patent Application Publication
(10) Pub. No.: US 2017/0184914 A1
(43) Pub. Date: Jun. 29, 2017

(54) LIQUID CRYSTAL DISPLAY AND MANUFACTURING METHOD THEREOF

(71) Applicant: Samsung Display Co., Ltd., Yongin-si (KR)

(72) Inventors: You Young JIN, Suwon-si (KR); Seong Gyu KWON, Suwon-si (KR); Sang Il KIM, Yongin-si (KR); Kwang Soo BAE, Suwon-si (KR)

(21) Appl. No.: 15/238,497

(22) Filed: Aug. 16, 2016

(30) Foreign Application Priority Data
Dec. 23, 2015 (KR) 10-2015-0185242

(51) Int. Cl. G02F 1/1333; G02F 1/1341; G02F 1/1343; G02F 1/1368; G02F 1/1362

(52) U.S. Cl. CPC G02F 1/133377; G02F 1/1368; G02F 1/136286; G02F 1/133345; G02F 1/134309; G02F 1/136213; G02F 1/1341; G02F 2001/134318; G02F 2001/134345

(57) ABSTRACT

A liquid crystal display (LCD) is presented. The LCD includes: a substrate; a plurality of thin film transistors disposed on the substrate; a plurality of liquid crystal (LC) layers disposed within a plurality of microcavities on the substrate; a partition wall disposed between the LC layers adjacent in a first direction; and signal lines disposed between the LC layers and the partition wall and connected to the plurality of thin film transistors.

### CROSS-REFERENCE TO RELATED APPLICATION

This application claims priority to and the benefit of Korean Patent Application No. 10-2015-0185242 filed in the Korean Intellectual Property Office on Dec. 23, 2015, the entire contents of which are incorporated herein by reference.

### BACKGROUND

### (a) Technical Field

The disclosure relates to a liquid crystal display (LCD) and a manufacturing method thereof.

### (b) Description of the Related Art

A liquid crystal display (LCD) is presently one of the most widely used display devices. The LCD displays an image by respectively applying a data voltage and a common voltage to a pixel electrode and a common electrode to generate an electric field, and changing an arrangement of liquid crystal molecules of a liquid crystal (LC) layer, using the generated electric field to control polarization of incident light.

Typically, the LCD has a structure in which the LC layer is formed between two substrates. Recently, a technique of manufacturing the LCD has been under development, which includes forming a tunnel-shaped structure that is a plurality of microcavities, injecting liquid crystals into each of the microcavities, and then sealing the microcavities.

The above information disclosed in this Background section is only to enhance the understanding of the background of the invention and therefore it may contain information that does not form the prior art that is already known in this country to a person of ordinary skill in the art.

### SUMMARY

An exemplary embodiment provides a liquid crystal display (LCD) capable of having increased resolution, and a manufacturing method thereof.

An exemplary embodiment provides an LCD having an improved contrast ratio, and a manufacturing method thereof.

An LCD according to an exemplary embodiment of the inventive concept includes: a substrate; a plurality of thin film transistors disposed on the substrate; a plurality of liquid crystal (LC) layers disposed within a plurality of microcavities on the substrate; a partition wall disposed between the LC layers adjacent in a first direction; and a signal line disposed between the LC layers and the partition wall and connected to the plurality of thin film transistors.

The signal line may extend in a second direction along one side surface of one of the LC layers.

The LCD may further include a semiconductor layer disposed between the LC layer and the signal line.

The LCD may further include a protruding portion disposed between the LC layers adjacent in the second direction. The signal line may extend along one side surface of the protruding portion in the second direction.

The LCD may further include a common electrode disposed between the substrate and the LC layers, and a pixel electrode disposed on the LC layers.

The LCD may further include a connecting portion connecting the pixel electrode and one of the plurality of thin film transistors. The connecting portion may extend along the other side surface of the one of the LC layers in the second direction. The connecting portion may extend along the other side surface of the protruding portion in the second direction.

The signal line and the connecting portion may not overlap in a plan view. The signal line and the connecting portion may at least partially overlap in a plan view.

The LCD may further include an insulating layer disposed on the pixel electrode. The pixel electrode and the insulating layer may have the same planar shape.

The common electrode may be divided to correspond to the plurality of LC layers.

The LCD may further include a dummy layer disposed between the substrate and the protruding portion. The common electrode may be connected to the dummy layer.

The LCD may further include a storage electrode line disposed on the substrate. The common electrode may be electrically connected to the storage electrode line.

The LCD may further include a gate insulating layer disposed between the storage electrode line and the common electrode. The common electrode may be connected to the storage electrode line through a contact hole formed in the gate insulating layer.

The signal line may extend along one side surface of the LC layer and a bottom surface of the partition wall in the second direction.

The LCD may further include a roof layer disposed on the plurality of LC layers. The partition wall may be a part of the roof layer that is disposed between the LC layers adjacent in the first direction

A manufacturing method of an LCD according to an exemplary embodiment of the inventive concept includes: forming a sacrificial layer on a substrate; forming a signal line extending along one side surface of the sacrificial layer; forming a roof layer on the sacrificial layer; forming a microcavity by removing the sacrificial layer; and forming a liquid crystal layer by injecting liquid crystals into the microcavity.

The method may further include forming a thin film transistor on the substrate.

The method may further include forming a common electrode layer on the substrate before forming the sacrificial layer, and forming a pixel electrode on the sacrificial layer before forming the signal line.

The method may further include forming a common electrode by etching the common electrode layer using the sacrificial layer as a mask.

The method may further include forming a storage electrode line including a gate line and an expansion protruding toward the gate line. The common electrode may be formed to include an expansion that overlaps the expansion of the storage electrode line.

The sacrificial layer may be formed to cover the expansion of the common electrode.

The thin film transistor may include a drain electrode, and the forming of the pixel electrode may include forming an extension that is connected to the drain electrode of the thin film transistor, and forming a connecting portion that connects the pixel electrode with the extension.

The signal line and the connecting portion may be formed to not overlap each other in a plan view.

The connecting portion may be formed to extend along an other side surface of the sacrificial layer.

The forming of the signal line may include forming the drain electrode on the extension to overlap the extension.

The forming of the sacrificial layer may include forming a protruding portion. The signal line may be formed to extend along the one side surface of the sacrificial layer and one side surface of the protruding portion.

The extension may be formed to extend along an other side surface of the sacrificial layer and the other side surface of the protruding portion.

The method may further include forming a semiconductor layer covering the sacrificial layer and the protruding portion after forming the pixel electrode.

The forming of the pixel electrode may include: forming a conductive material layer on the sacrificial layer; forming an inorganic material layer on the conductive material layer; forming an insulating layer by etching the inorganic material layer into the shape of the pixel electrode; and forming the pixel electrode using the insulating layer as a mask.

According to the current exemplary embodiment of the inventive concept, a distance between the adjacent pixels can be reduced, thereby increasing resolution of the LCD. In addition, since light leakage can be reduced around the partition, a contrast ratio can be improved. Further, since a planar area of the signal line decreases, light reflection produced by the signal line can be reduced.

### BRIEF DESCRIPTION OF THE DRAWINGS

FIG. 1 is a schematic plan view of a liquid crystal display (LCD) according to an exemplary embodiment of the inventive concept.

FIG. 2 is a layout view of two pixel areas in the LCD according to the exemplary embodiment of the inventive concept.

FIG. 3 is a cross-sectional view of FIG. 2 taken along the line III-III.

FIG. 4 is a cross-sectional view of FIG. 2 taken along the line IV-IV.

FIG. 5 is a cross-sectional view of FIG. 2 taken along the line V-V.

FIGS. 6, 7, 8, 9, 10, 11, 12, 13, 14, 15, 16, 17, 18, 19, 20, 21, 22, 23, 24, 25, and 26 are processing cross-sectional views illustrating a manufacturing method of an LCD according to an exemplary embodiment of the inventive concept.

FIG. 27 is a layout view of two pixel areas in an LCD according to an exemplary embodiment of the inventive concept.

FIG. 28 is a cross-sectional view of FIG. 27 taken along the line IV-IV.

FIG. 29 is a cross-sectional view of FIG. 27 taken along the line V-V.

FIG. 30 is a layout view of two pixel areas in an LCD according to an exemplary embodiment of the inventive concept.

FIG. 31 is a cross-sectional view of FIG. 30 taken along the line IV-IV.

FIG. 32 is a cross-sectional view of FIG. 30 taken along the line V-V.

### DETAILED DESCRIPTION OF THE EMBODIMENTS

The inventive concept will be described more fully hereinafter with reference to the accompanying drawings, in which exemplary embodiments are shown. As those skilled in the art would realize, the described embodiments may be modified in various different ways, all without departing from the spirit or scope of the inventive concept.

Like reference numerals designate like elements throughout the specification. In the drawings, the thickness or sizes of respective layers and regions may be enlarged or reduced to clearly illustrate their arrangements and relative positions.

In the terms used in the specification, it will be understood that when an element such as a layer, film, region, or substrate is referred to as being “on” another element, it can be directly on the other element or intervening elements may also be present. In contrast, when an element is referred to as being “directly on” another element, there are no intervening elements present. Unless otherwise noted in the specification, “overlap” means that at least part of a layer, film, region, or substrate overlaps another element when viewed in a plan view.

A liquid crystal display (LCD) according to an exemplary embodiment of the inventive concept will be described in detail with reference to the drawings.

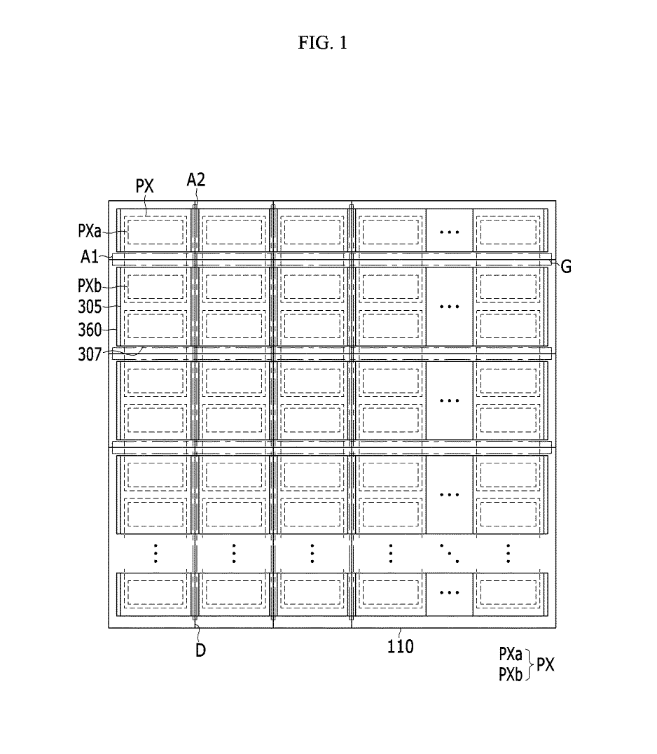

FIG. 1 is a schematic plan view of a liquid crystal display (LCD) according to an exemplary embodiment of the inventive concept.

Referring to FIG. 1, the LCD according to the current exemplary embodiment includes a plurality of pixels PX arranged on a substrate 110 that can be made of a transparent insulating material such as glass or plastic. The plurality of pixels PX may be arranged in a matrix form. Each pixel PX may include a first subpixel PXa and a second subpixel PXb. Each pixel PX includes a pixel electrode (not shown) which is a field generating electrode, a common electrode (not shown), and a liquid crystal (LC) layer (not shown) disposed therebetween.

Signal lines such as a plurality of gate lines G and a plurality of data lines D are disposed on the substrate 110. The gate lines G mainly extend in a row (horizontal) direction, and transmit a gate signal including a gate-on voltage and a gate-off voltage. The data lines D mainly extend in a column (vertical) direction, and transmit a data voltage. Unlike as illustrated, the gate lines G may mainly extend in a column direction while the data lines D may mainly extend in a row direction, and both of the gate lines G and the data lines D may mainly extend in the column direction or in the row direction.

The pixel electrode of the pixel PX is connected to the data line via a switching element such as a thin film transistor (not shown), and receives the data voltage. The same data voltage may be applied to the first subpixel PXa and the second subpixel PXb of one pixel PX, or different data voltages may be applied thereto. The first and second subpixels PXa and PXb may exhibit the same luminance. One of the first and second subpixels PXa and PXb may exhibit relatively high luminance, while the other may exhibit relatively low luminance.

In addition, a plurality of roof layers 360 and a plurality of microcavities 305 covered by the roof layers 360 are included on the substrate 110. Each roof layer 360 may extend in the row direction, which is a first direction, and the plurality of roof layers 360 may be separated from each other in the column direction, which is a second direction, while interposing the first region A1 extending in the row direction therebetween. The first region A1 is also called a trench.

The microcavity 305 is a three-dimensional region defined substantially by the roof layer 360, and an LC layer is formed inside the microcavity 305. The plurality of microcavities 305 are separated from each other in the column direction while interposing the first region A1 therebetween, and are separated from each other in the row direction while interposing the second region A2 extending in the column direction therebetween. The second region A2 is also called a partition wall. The microcavity 305 includes an inlet 307 that allows the LC to be injected when the LC layer is formed. The inlet 307 may be disposed adjacent in the column direction to the first region A1. Each microcavity 305 may correspond to two subpixels. That is, in the two pixels PX that are adjacent in the column direction, one microcavity 305 may correspond to the first subpixel PXa of one pixel and the second subpixel PXb of the other pixel. However, one microcavity 305 may also correspond to one subpixel, or may correspond to three or more subpixels.

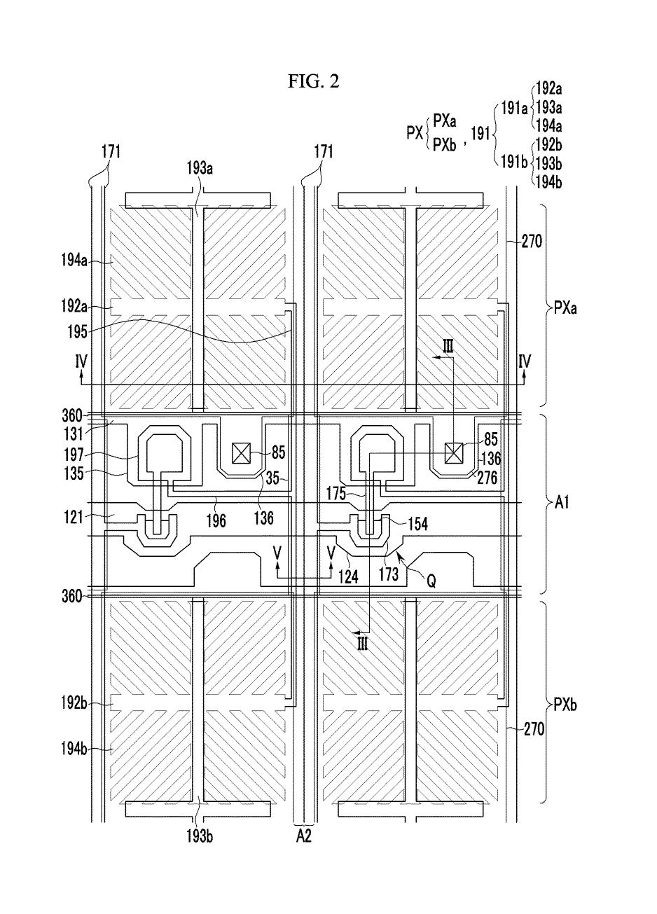

The LCD according to the current exemplary embodiment of the inventive concept will now be described in more detail with reference to FIGS. 2 to 5.

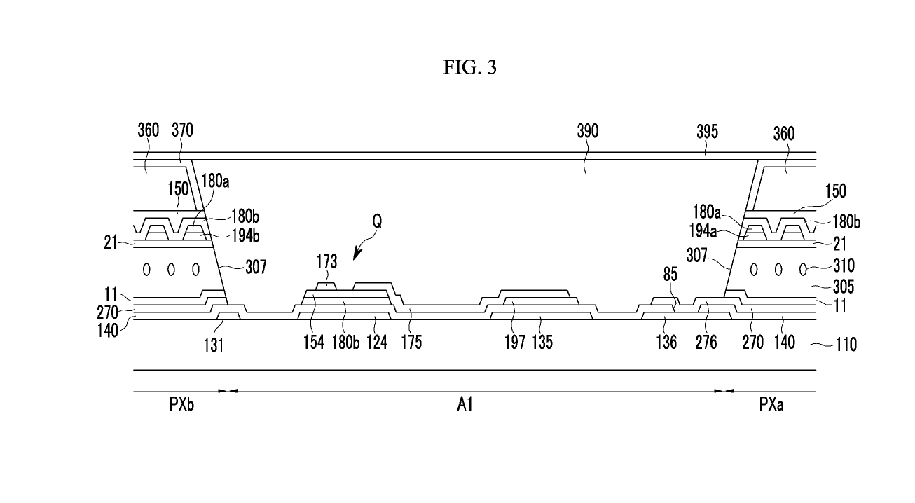

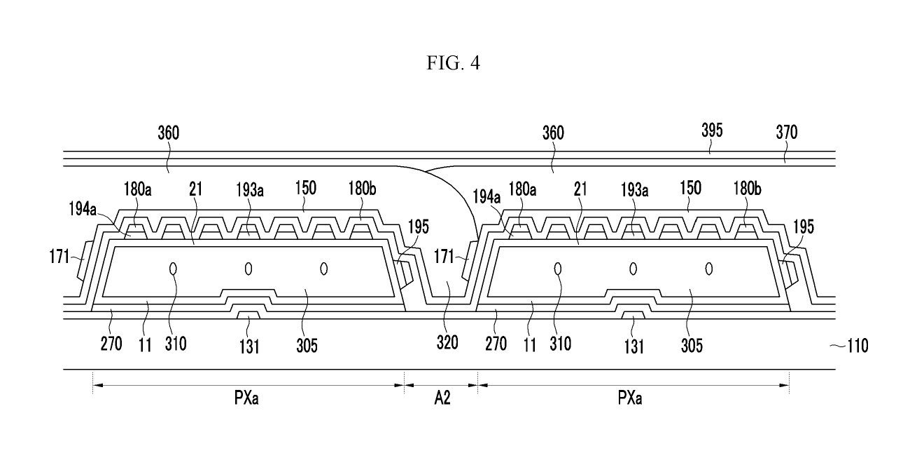

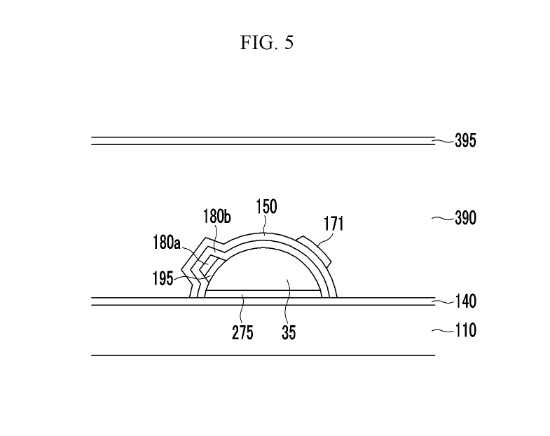

FIG. 2 is a layout view of two pixel areas in the LCD according to the exemplary embodiment of the inventive concept. FIG. 3 is a cross-sectional view of FIG. 2 taken along the line III-III, FIG. 4 is a cross-sectional view of FIG. 2 taken along the line IV-IV, and FIG. 5 is a cross-sectional view of FIG. 2 taken along the line V-V.

Referring to FIG. 2, of the pixels illustrated in FIG. 1, a structure of the pixel disposed in a region corresponding to the two adjacent pixels in the row direction is illustrated in detail. Such a pixel may be disposed across the entire substrate 110 in the row and column directions.

Referring to FIGS. 2 to 5, a gate line 121 and a storage electrode line 131 is formed on the transparent substrate 110 that can be made of glass or plastic.

The gate lines 121 substantially extending in the row direction transmit the gate signal. Each gate line 121 includes a gate electrode 124 that forms a thin film transistor Q in the pixel area.

The storage electrode line 131 substantially extends in the row direction as does the gate line 121 and is formed to be separated from the gate line 121, and transmits a predetermined voltage such as a common voltage. The storage electrode line 131 may protrude toward a pixel electrode 191 in the column direction. Though not illustrated, the storage electrode line 131 may have a structure that at least surrounds at least some of the pixel electrode 191. The storage electrode line 131 may or may not overlap some of the pixel electrode 191. The storage electrode line 131 includes a storage electrode 135 and an expansion 136 that protrude toward the gate line 121 in the column direction.

The gate line 121, the gate electrode 124, the storage electrode line 131, the storage electrode 135, and the expansion 136 may be formed of the same material, and they may be called gate conductors. The gate conductors may be made of a metal such as aluminum (Al), silver (Ag), copper (Cu), molybdenum (Mo), chromium (Cr), tantalum (Ta), titanium (Ti), etc., or an alloy thereof. The gate conductor may be formed as a single layer or multiple layers.

A gate insulating layer 140 is disposed on the gate conductor. The gate insulating layer 140 substantially covers the gate conductor, but is formed with a contact hole 85 that overlaps a portion of the expansion 136 of the storage electrode line 131. The gate insulating layer 140 may be made of an inorganic material such as a silicon nitride (SiNx) or a silicon oxide (SiOx), and may be formed as a single layer or multiple layers.

A common electrode 270 is disposed on the gate insulating layer 140. The common electrode 270 is divided to correspond to the microcavities 305 and thus is also divided by the LC layers. Specifically, in one pixel PX, the common electrode 270 is divided in the column direction along the first region A1 where the gate line 121 extends. In addition, in the pixels PX which are adjacent in the row direction, the common electrode 270 is divided in the row direction along the second region A2 where a data line 171 extends. However, in the pixels PX which are adjacent in the column direction, the common electrode 270 spans between the first subpixel PXa of one pixel PX and the second subpixel PXb of the other pixel PX. Referring to FIG. 1, the common electrode 270 is divided by the first region A1 and the second region A2 that cross each other. The common electrode 270 includes an expansion 276 that protrudes toward the gate line 121. The expansion 276 of the common electrode 270 is connected to the expansion 136 of the storage electrode line 131 through the contact hole 85 that is formed in the gate insulating layer 140. Accordingly, the common electrode 270 may receive the common voltage from the storage electrode line 131 even if it is formed to be separated so as to correspond to the microcavities 305. The separated common electrodes 270 may be connected to a dummy layer 275 to be described below such that they are electrically coupled to each other.

The common electrode 270 may be made of a transparent conductive oxide such as indium tin oxide (ITO) or indium zinc oxide (IZO).

In some exemplary embodiments, the common electrode 270 may also be formed such that it is not divided across an entire surface of the substrate 110 between the substrate 110 and the gate conductor while interposing the insulating layer therebetween. In this case, the common voltage may be provided to the common electrode 270 from an edge region of the substrate 110, and simultaneously or separately, the expansion 136 of the storage electrode line 131 may be connected to the common electrode 270 through the contact hole formed in the insulating layer to transmit the common voltage to the common electrode 270.

In a region where the first region A1 and the second region A2 substantially overlap each other, the dummy layer 275 is formed on the gate insulating layer 140. Accordingly, the dummy layer 275 is disposed between the two pixels PX which are adjacent in the row direction, and simultaneously, is disposed between the two subpixels PXa and PXb of one pixel PX. A width of the dummy layer 275 may be similar to or greater than, or smaller than, that of the second region A2. The dummy layer 275 may be formed on the same layer as the common electrode 270 and of the same material as the common electrode 270. The dummy layer 275 may be connected to the common electrode 270, or may be formed to electrically connect common electrodes 270 that are separated from each other. The dummy layer 275 may be separated from the common electrode 270 to be in an electrically floating state. The dummy layer 275 may not be formed.

A protruding portion 35 is disposed on the dummy layer 275. The protruding portion 35 and the dummy layer 275 may have substantially the same planar shape, and may completely overlap each other. The protruding portion 35 may be made of an organic material. For example, the protruding portion 35 may be a part of a sacrificial layer that is used when forming the microcavity 305. The protruding portion 35 may also be formed using an organic material layer that is different from the sacrificial layer. The protruding portion 35 may be formed to extend along the second region A2 while having a predetermined height within the first region A1. When a cell gap corresponding to a height of the microcavity 305 is, for example, about 3 μm, the protruding portion 35 may be formed to have a height of less than about 3 μm, for example, a height of about 1 μm to about 3 μm. In FIG. 2, the protruding portion 35 is illustrated to be slightly larger than a width of the second region A2, but it may be similar to or smaller than the width of the second region A2. A top surface of the protruding portion 35 is illustrated to be round in FIG. 5, but it is not limited thereto, and it may include a substantially flat portion.

The pixel electrode 191 spaced apart from the common electrode 270 by interposing the microcavity 305 therebetween is disposed on the common electrode 270. The LC layer including LC molecules 310 is disposed inside the microcavity 305.

The pixel electrode 191 includes a first subpixel electrode 191a corresponding to the first subpixel PXa, and a second subpixel electrode 191b corresponding to the second subpixel PXb. The first and second subpixel electrodes 191a and 191b are separated from each other while interposing the first region A1 therebetween. Accordingly, the pixel electrode 191 is divided into the two subpixel electrodes 191a and 191b in the column direction while interposing the gate line 121 therebetween. The first and second subpixel electrodes 191a and 191b may be disposed only on a top surface of the microcavity 305, and may not be disposed at a side surface of the microcavity 305.

Each of the first and second subpixel electrodes 191a and 191b may have a substantially quadrangular shape. Each of the first and second subpixel electrodes 191a and 191b may include a cross-shaped stem portion that includes horizontal stem portions 192a and 192b and vertical stem portions 193a and 193b perpendicular thereto. In addition, each of the first and second subpixel electrodes 191a and 191b may include a plurality of minute branch portions 194a and 194b.

Each of the first and second subpixel electrodes 191a and 191b is divided into four domains by the cross-shaped stem portion. When applying an electric field, a wide viewing angle can be implemented since the LC molecules 310 are differently controlled such that their tilt directions are different in these four subregions. The minute branch portions 194a and 194b obliquely extend from the cross-shaped stem portion such that their extending directions may form an angle of about 45° or about 135° with the horizontal stem portions 192a and 192b. In the two vertically and horizontally neighboring domains, the extending directions of minute branch portions 194a and 194b may be perpendicular to each other. In addition, widths of the minute branch portions 194a and 194b may become gradually wider, or a gap between the minute branch portions 194a may be different from that between the minute branch portions 194b. Each of the first and second subpixel electrodes 191a and 191b may further include an outer stem portion (not shown) that connects the minute branch portions 194a and 194b from the outside.

An extension 197 of the pixel electrode is formed on the gate insulating layer 140 to overlap the storage electrode 135. The extension 197 is physically and electrically connected to a drain electrode 175 of the thin film transistor Q. The first and second subpixel electrodes 191a and 191b are connected to the extension 197 via connecting portions 195 and 196. Accordingly, the data voltage applied to the extension 197 via the drain electrode 175 is transmitted to the first and second subpixel electrodes 191a and 191b via the connecting portions 195 and 196.

The extension 197 and the storage electrode 135, along with the gate insulating layer 140 therebetween, form a storage capacitor. The common voltage is applied via the storage electrode line 131 to the storage electrode 135 which is one electrode of the storage capacitor, and the data voltage is applied via the drain electrode 175 of the thin film transistor Q to the extension 197 which is the other electrode of the storage capacitor. The storage capacitor maintains the applied voltage even after the thin film transistor Q is turned off.

The inlet 307 of the microcavity 305 may make it difficult for the extension 197 to directly extend from the first and second subpixel electrodes 191a and 191b that are formed on the top surface of the microcavity 305. Accordingly, the extension 197 is formed to indirectly extend via the connecting portions 195 and 196. The connecting portions 195 and 196 include a first connecting portion 195 substantially extending in the column direction, and a second connecting portion 196 substantially extending in the row direction.

One end of the first connecting portion 195 is connected to the first subpixel electrode 191a, while the other end of the first connecting portion 195 is connected to the second subpixel electrode 191b. In the illustrated exemplary embodiment, the first connecting portion 195 is connected to one end of each of the horizontal stem portions 192a and 192b of the first and second subpixel electrodes 191a and 191b. However, the first connecting portion 195 may be connected to the minute branch portions 194a and 194b, or the outer stem portion (not shown), etc., of the first and second subpixel electrodes 191a and 191b.

The first connecting portion 195 may include a portion that is formed along the side surface of the microcavity 305 corresponding to a side surface of the LC layer, and a portion that is formed along a side surface of the protruding portion 35. In other words, the first connecting portion 195 may extend along the side surface of the microcavity 305 (which corresponds to the side surface of the LC layer) in a region where the microcavity 305 is disposed, and may extend along the side surface of the protruding portion 35 in the first region A1 where the microcavity 305 is not disposed. Accordingly, most of the first connecting portion 195 may be formed to be inclined with a planar surface of the substrate 110 while not being substantially parallel thereto.

One end of the second connecting portion 196 is connected to the first connecting portion 195 while the other end thereof is connected to the extension 197, and transmits the voltage applied to the extension 197 to the first connecting portion 195.

The pixel electrode 191, the connecting portions 195 and 196, and the extension 197 may be formed of the same material, and they may be called pixel conductors. The pixel conductors may be made of a transparent conductive oxide such as ITO or IZO.

A first insulating layer 180a is formed on the pixel electrode 191. The first insulating layer 180a may have substantially the same planar shape as the first and second subpixel electrodes 191a and 191b. The first insulating layer 180a may be disposed on the first connecting portion 195 of the pixel conductors other than the pixel electrode 191, but may not be disposed on the second connecting portion 196. The first insulating layer 180a is not disposed on the extension 197. The first insulating layer 180a may be made of an inorganic material such as a silicon nitride or a silicon oxide.

A second insulating layer 180b is formed on the first insulating layer 180a. The second insulating layer 180b is also formed on the gate insulating layer 140 to overlap the gate electrode 124 of the thin film transistor Q. The second insulating layer 180b may be made of an inorganic material such as a silicon nitride or a silicon oxide.

A semiconductor layer 150 and a semiconductor 154 are disposed on the second insulating layer 180b. The second insulating layer 180b, the semiconductor layer 150, and the semiconductor 154 may have substantially the same planar shape, and they may completely overlap each other.

The data line 171, a source electrode 173, and the drain electrode 175 are formed on the semiconductor layer 150, the semiconductor 154, and the gate insulating layer 140. The data line 171, the source electrode 173, and the drain electrode 175 may be formed of the same material, and they may be called data conductors. The data conductor may be made of a metal such as molybdenum, chromium, tantalum, titanium, etc., or an alloy thereof, and may be formed as a single layer or multiple layers.

The gate electrode 124, the source electrode 173, and the drain electrode 175 form the thin film transistor Q along with the semiconductor 154, and a channel of the thin film transistor Q is formed at a portion of the semiconductor 154 between the source electrode 173 and the drain electrode 175. Ohmic contacts (not shown) may be formed between the semiconductor 154 and the source and the drain electrodes 173 and 175. The ohmic contacts may be made of a silicide or a material such as n+ hydrogenated amorphous silicon in which an n-type impurity is doped at a high concentration. The source electrode 173 is connected to the data line 171, and the drain electrode 175 is formed further on the extension 197 of the pixel electrode. The first and second insulating layers 180a and 180b are not disposed on the extension 197, so the drain electrode 175 may be formed to contact the extension 197.

The data line 171 substantially extending in the column direction includes a portion that is formed along the side surface of the microcavity 305, and a portion that is formed along the side surface of the protruding portion 35. In other words, the data line 171 extends along the side surface of the microcavity 305 (which corresponds to the side surface of the LC layer) in the region where the microcavity 305 is disposed, and extends along the side surface of the protruding portion 35 in the first region A1 where the microcavity 305 is not disposed. Most of the data line 171, except for a portion thereof extending in the row direction to be connected to the source electrode 173, is formed to be inclined with the planar surface of the substrate 110 while not being substantially parallel thereto. Accordingly, compared with a case in which the data line 171 of the same line width is formed to be parallel to the planar surface of the substrate 110, an area occupied by the data line 171 may be reduced in a plan view. As a result, a distance between the adjacent microcavities 305 (as well as a width of the partition wall 320 to be described below) may be reduced, and thus the number of pixels to be disposed within a display device of the same size may be increased (resolution may be increased). In addition, LC control is weakened at the side surface of the microcavity 305 (e.g., orientation of the LC molecules 310 is disordered) and thus light leakage may occur, and the data line 171 is formed at the side surface of the microcavity 305 such that the light leakage can be reduced by preventing the light leakage, so black luminance can be decreased to improve a contrast ratio. In addition, since an area occupied by the data line 171 is reduced, light reflection caused by the data line 171 may be reduced.

In the portion where the data line 171 extends along the side surface of the microcavity 305, the semiconductor layer 150 and the second insulating layer 180b may be disposed between the data line 171 and the microcavity 305. In the portion where the data line 171 extends along the side surface of the protruding portion 35, the semiconductor layer 150 and the second insulating layer 180b may be disposed between the data line 171 and the protruding portion 35.

Referring to FIGS. 2, 4, and 5, the microcavity 305 includes two side surfaces in the row direction. The data line 171 is disposed at one of the two side surfaces while the first connecting portion 195 for connecting the first and second subpixel electrodes 191a and 191b to the second connecting portion 196 is disposed at the other side surface thereof. If one side surface is called a left side surface and the other side surface is called a right side surface, the data line 171 is disposed at the left side surface while the first connecting portion 195 is disposed at the right side surface. That is, when the data line 171 is formed to be connected to the pixel on its right side (or thin film transistor), the data line can minimize interference with other components. For example, when the data line 171 is connected to the pixel on its right side, it may be advantageous for the data line 171 to be disposed at the right side surface of the microcavity 305 while the second connecting portion 196 is disposed at the left side surface thereof.

In the first region A1, the first connecting portion 195 connecting the first and second subpixel electrodes 191a and 191b to the second connecting portion 196 may extend along the left side surface of the protruding portion 35, while the data line 171 extends along the right side surface of the protruding portion 35. As a result, in the first region A1, an area in a plan view occupied by the data line 171 and the first connecting portion 195 can be reduced, so an area for disposing various other components in the first region A1 can be secured. In addition, since the distance between the data line 171 and the first connecting portion 195 may increase as compared to when they are formed to be parallel to the planar surface of the substrate 110, capacitance between them can be reduced to reduce a coupling effect. When the data line 171 is connected to the pixel (or the thin film transistor) on its right side, the data line 171 may extend along the right side surface of the protruding portion 35, while the first connecting portion 195 may be formed to extend along the left side surface of the protruding portion 35.

One or more passivation layers (not shown) made of an inorganic material or an organic material may be formed on the data conductors.

A lower alignment layer 11 and an upper alignment layer 21 are formed at an inner surface of the microcavity 305. Specifically, the lower alignment layer 11 is formed on the common electrode 270, and the upper alignment layer 21 is formed under the pixel electrode 191. The lower alignment layer 11 and the upper alignment layer 21 may be vertical alignment layers. The lower alignment layer 11 and the upper alignment layer 21 may be formed by including at least one of materials generally used in an LC alignment layer such as polyamic acid, polysiloxane, and polyimide. The lower alignment layer 11 and the upper alignment layer 21 may be photoalignment layers. The lower alignment layer 11 and the upper alignment layer 21 may be connected to each other along the side surface of the microcavity 305.

An LC material including the LC molecules 310 is injected between the lower and upper alignment layers 11 and 21 inside the microcavity 305, thereby forming the LC layer. An aligning material for forming the alignment layers 11 and 21 and the LC material including the LC molecules 310 may be injected into the microcavity 305 using a capillary force, and the microcavity 305 includes the inlet 307 for such injection.

Over the microcavity 305, a roof layer 360 is disposed on the semiconductor layer 150. The roof layer 360 serves to support and form the microcavity 305 which is a space between the common electrode 270 and the pixel electrode 191.

The roof layer 360 may include a photoresist or other organic materials. A portion of the roof layer 360 disposed between the adjacent microcavities 305 in the row direction forms the partition wall 320. The partition wall 320 fills a space between the microcavities 305 that neighbor each other in the row direction, and is disposed along the second region A2. The partition wall 320 may partition or define the microcavity 305. Generally, the data line 171 extends while being disposed under the partition wall 320. Generally, the partition wall 320 is formed to have a width that allows the microcavity 305 and the data line 171 to not overlap each other, and this is because, when the data line 171 and the microcavity 305 overlap each other, an aperture ratio deteriorates and coupling between the data line 171 and the common electrode 270 or the pixel electrode 191 increases. However, in the current exemplary embodiment of the inventive concept, since the data line 171 extends along the side surface of the partition wall 320, such a decrease in aperture ratio or an increase in coupling is not so important even if the distance between the adjacent microcavities 305 is reduced, so the width of the partition wall 320 can be reduced. The data line 171 and the partition wall 320 may be formed to contact each other. The roof layer 360 may be formed as a color filter. In this case, as shown in FIG. 4, color filters of different colors may overlap between the adjacent microcavities 305 to form the partition wall 320. On the other hand, the roof layer 360 may include an inorganic material.

An upper insulating layer 370 is disposed on the roof layer 360. The upper insulating layer 370 may be formed of an inorganic material such as a silicon nitride or a silicon oxide.

An encapsulation layer 390 is formed in the first region A1. The encapsulation layer 390 covers the inlet 307 to seal the microcavity 305, so the LC molecules 310 disposed inside the microcavity 305 are prevented from leaking out of the microcavity 305. The encapsulation layer 390 may include an organic material or an inorganic material, and may be formed as a single layer or multiple layers. The encapsulation layer 390 may include a light blocking material, and may function as a light blocking member. In this case, the encapsulation layer 390 may also be formed in the second region A2, but it is not formed on the microcavity 305 (i.e., is formed to not overlap the microcavity 305).

The encapsulation layer 390 may be formed of a transparent material, and in this case, the encapsulation layer 390 may be formed on the microcavity 305 as well as in the first and second regions A1 and A2. For example, the encapsulation layer 390 may be formed across the entire substrate 110.

A barrier layer 395 preventing permeation of external moisture, oxygen, etc. may be disposed on the encapsulation layer 390 and the upper insulating layer 370. The barrier layer 395 may be formed of an inorganic material or an organic material.

Though not illustrated, polarizers may be disposed at top and bottom surfaces of the display device. The polarizers may include a first polarizer and a second polarizer, and the first polarizer may, for example, be attached to the bottom surface of the substrate 110 while the second polarizer may be attached onto the barrier layer 395.

In the aforementioned exemplary embodiment, a case in which the data line 171 extends along the side surface of the microcavity 305 and the side surface of the protruding portion 35 is exemplarily illustrated, but another signal line such as the gate line 121 may also be formed to extend the side surface of the microcavity 305 and/or the side surface of the protruding portion 35.

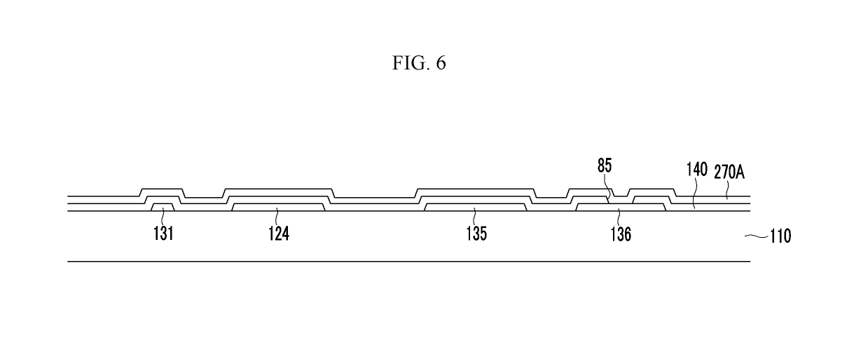

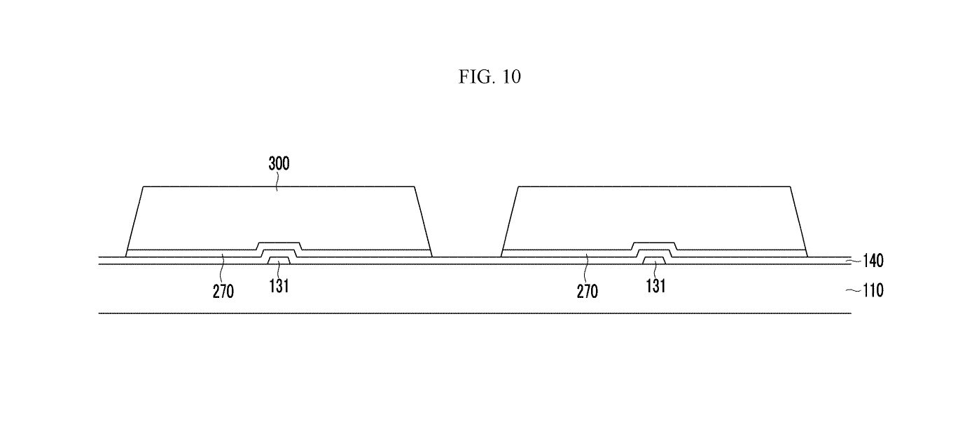

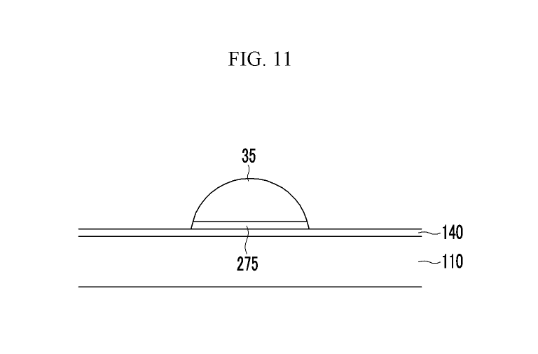

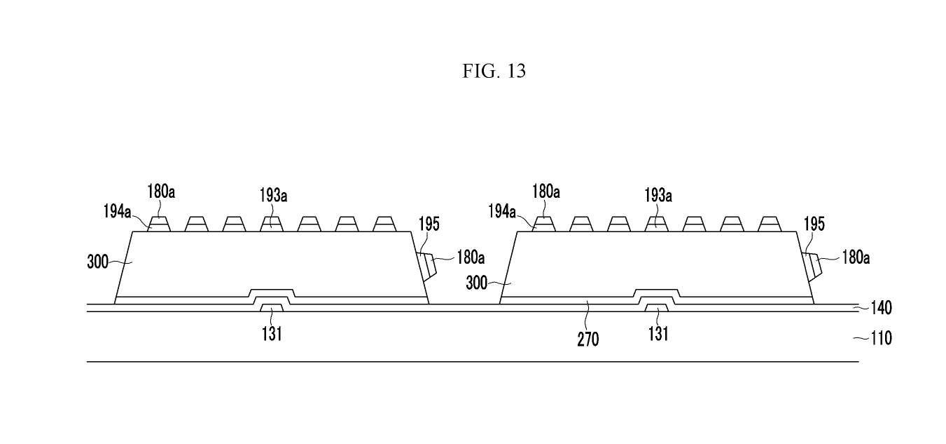

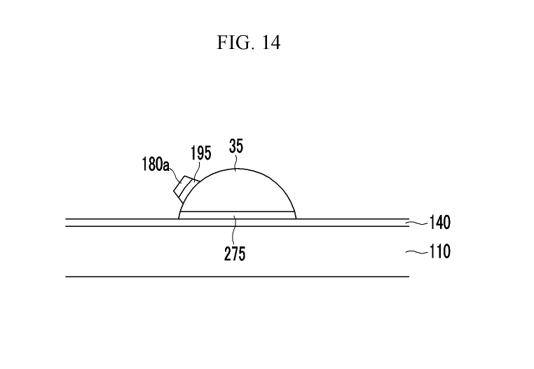

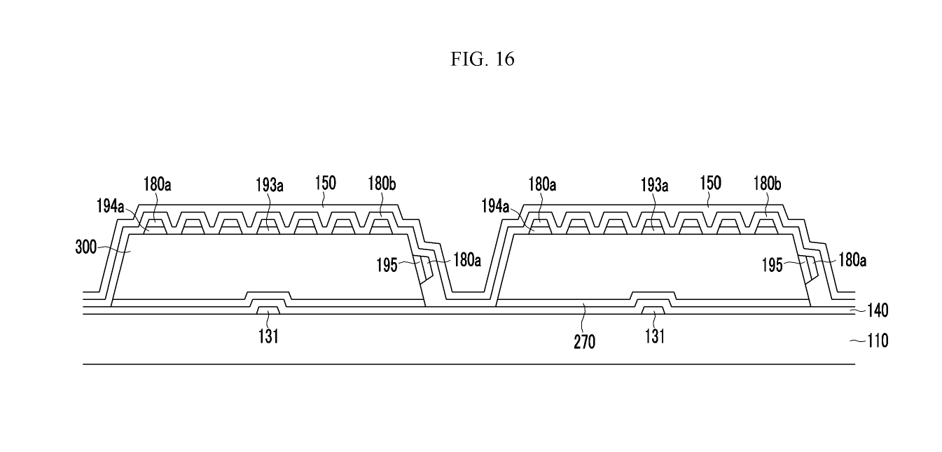

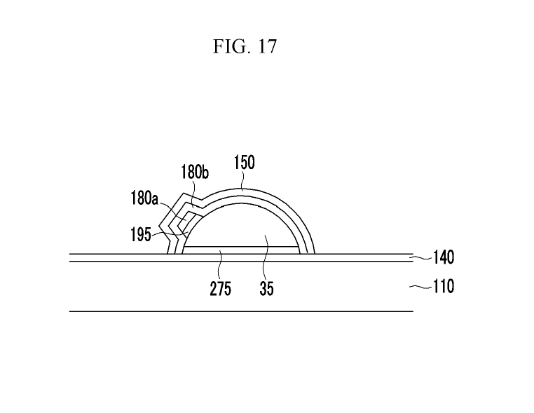

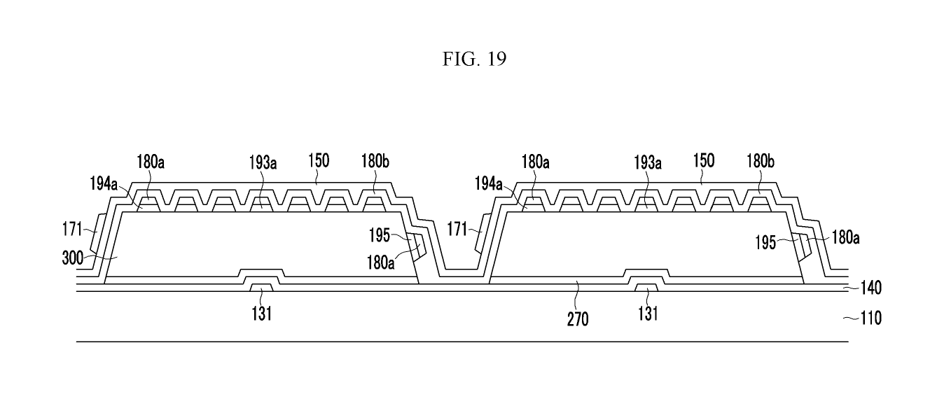

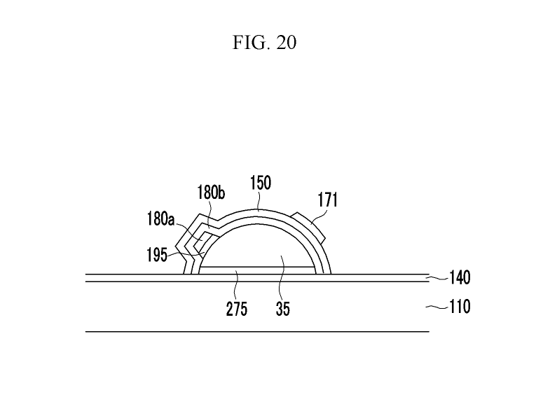

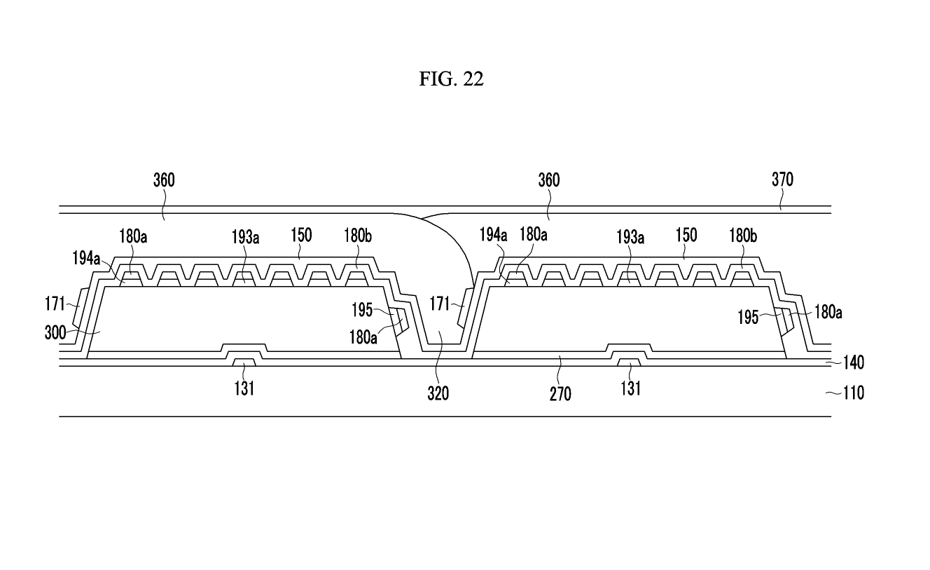

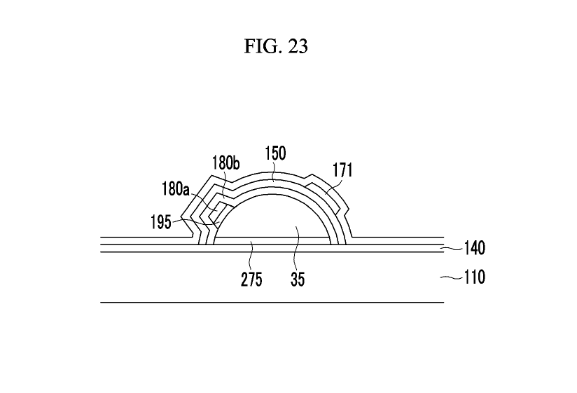

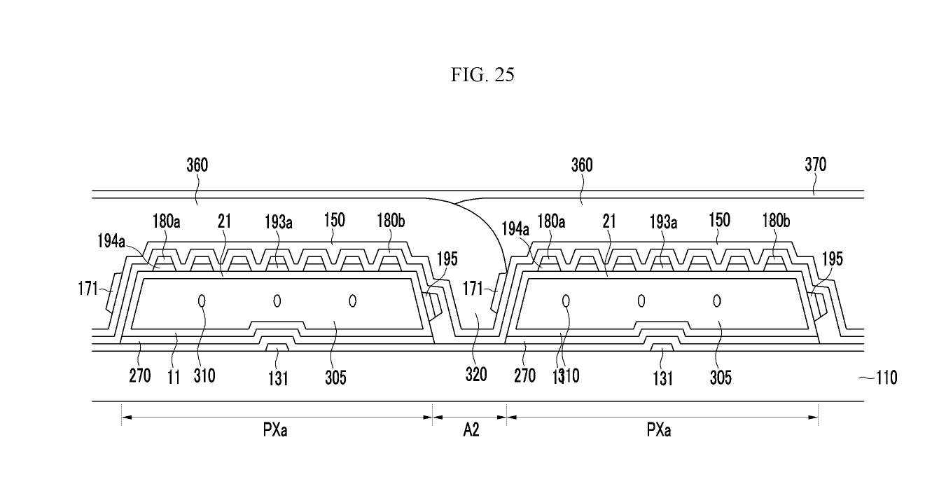

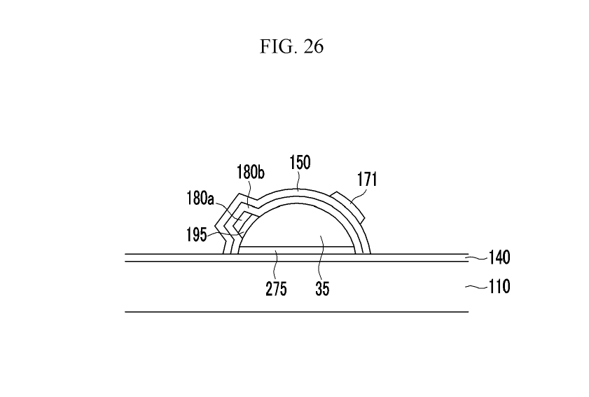

An exemplary embodiment of a method for manufacturing the LCD described above will now be described with reference to FIGS. 6 to 26.

FIGS. 6 to 26 are processing cross-sectional views illustrating a manufacturing method of an LCD according to an exemplary embodiment of the inventive concept.

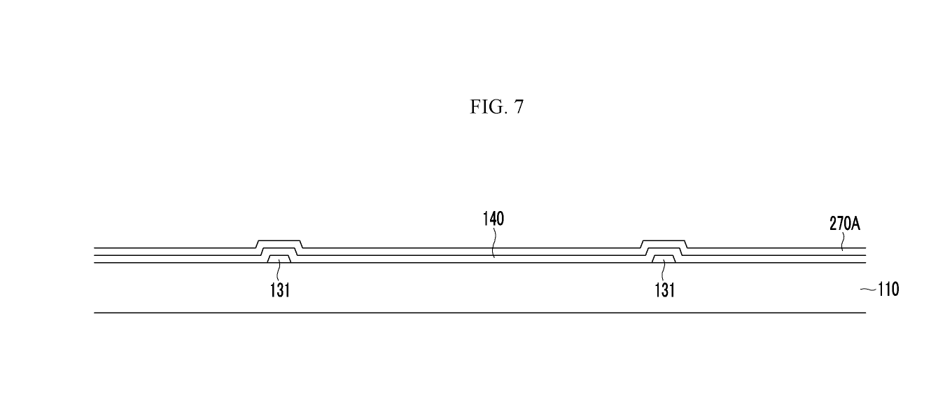

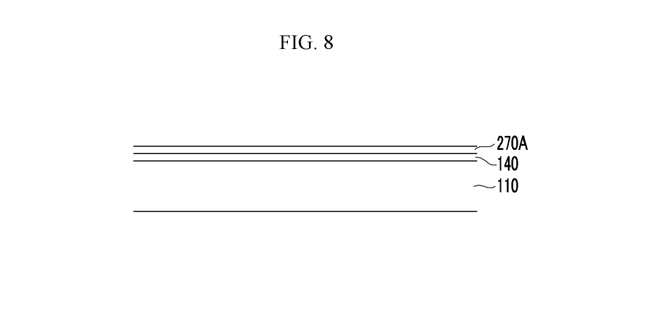

FIGS. 6, 9, 12, 15, 18, 21, and 24 are drawings that sequentially illustrate cross-sections of FIG. 2 taken along the line III-III, FIGS. 7, 10, 13, 16, 19, 22, and 25 are drawings that sequentially illustrate cross-sections of FIG. 2 taken along the line IV-IV, and FIGS. 8, 11, 14, 17, 20, 23, and 26 are drawings that sequentially illustrate cross-sections of FIG. 2 taken along the line V-V. Even if not otherwise noted, reference may be made to FIGS. 1 through 4 as well.

Referring to FIGS. 6, 7, and 8, a gate line 121, a gate electrode 124, a storage electrode line 131, a storage electrode 135, and an expansion 136 are formed as gate conductors on a substrate 110, and a gate insulating layer 140 is formed thereon. Next, a contact hole 85 partially exposing the expansion 136 is formed in the gate insulating layer 140, and a common electrode layer 270A is formed. In this case, the common electrode layer 270A is physically and electrically connected to the expansion 136 through the contact hole 85.

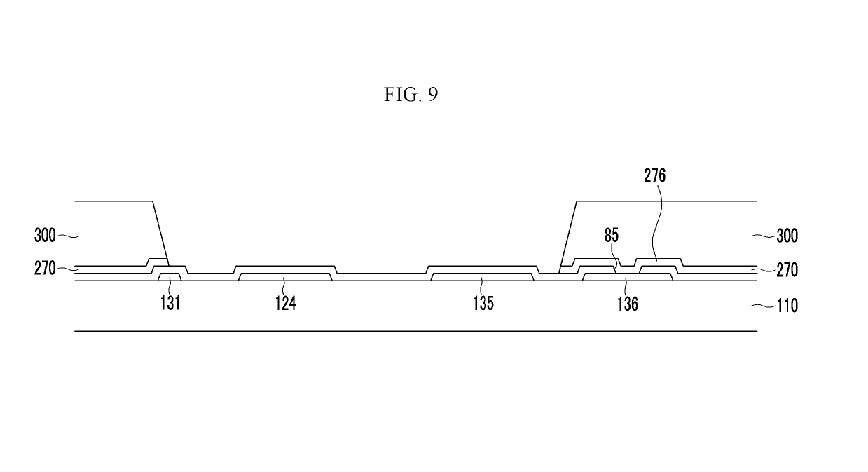

Referring to FIGS. 9, 10, and 11, a photosensitive organic material is coated on the common electrode layer 270A, and a sacrificial layer 300 and a protruding portion 35 are formed by a photolithography process. In this case, the sacrificial layer 300 is generally formed at a position corresponding to a microcavity 305, and is formed to cover the expansion 276 of the common electrode 270. The sacrificial layer 300 is removed in a subsequent process for forming the microcavity 305, but a protruding portion 35 is not removed and remains in an LCD. The protruding portion 35 is formed to have substantially the same height as the sacrificial layer 300, or may be formed to have a lower height than the sacrificial layer 300. In the latter case, a halftone mask or a slit mask may be used in the photolithography process. However, when having a considerably smaller width than the sacrificial layer 300, the protruding portion 35 may be formed to be lower than the sacrificial layer 300 even without using the halftone mask.

As such, the protruding portion 35 may be integrally formed with the sacrificial layer 300, but may also be formed to be separated therefrom. For example, the protruding portion 35 may be formed using an organic material or the like before forming the sacrificial layer 300. The protruding portion 35 may be formed to be separated from the sacrificial layer 300, or may be formed to be connected to the sacrificial layer 300.

After forming the sacrificial layer 300 and the protruding portion 35, an exposed portion of the common electrode layer 270A is etched using the sacrificial layer 300 and the protruding portion 35 as a mask, thereby forming a common electrode 270. Accordingly, the common electrode 270 may be separately formed in regions corresponding to each microcavity 305. That is, the common electrode 270 is divided in a matrix form by a first region A1 and a second region A2. However, because the expansion 276 remains since it is covered by the sacrificial layer 300, each of the divided common electrodes 270 may receive a common voltage, which is transmitted via a storage electrode line 131, via the expansion 276 contacting the expansion 136 of the storage electrode line 131. The common electrode 270 covered by the protruding portion 35 remains as a dummy layer 275 under the protruding portion 35. The dummy layer 275 is separated from the common electrode 270 that is formed in a region corresponding to the microcavity 305. However, when the sacrificial layer 300 and the protruding portion 35 are connected to each other, the dummy layer 275 may be connected to the common electrode 270.

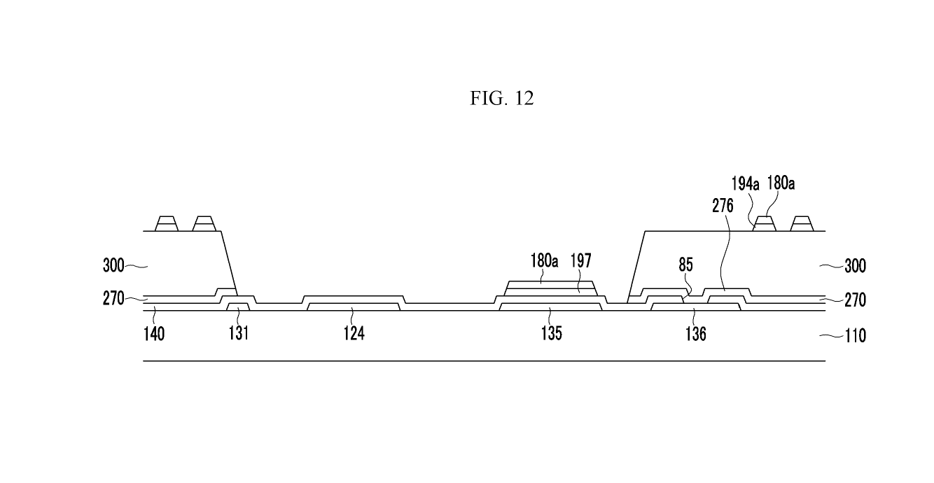

Referring to FIGS. 12, 13, and 14, a transparent conductive material such as ITO or IZO is deposited on the sacrificial layer 300, and then an inorganic material such as a silicon nitride film or a silicon oxide film is deposited. Next, an inorganic material layer is etched into the shape of the pixel electrode 191 by the photolithography process, thereby forming a first insulating layer 180a. Next, a transparent conductive material layer is etched using the first insulating layer 180a as a mask, thereby forming a pixel electrode 191. First and second subpixel electrodes 191a and 191b may be formed only on a top surface of the sacrificial layer 300.

When forming the first and second subpixel electrodes 191a and 191b, the extension 197 of the pixel electrode 191 is formed on the gate insulating layer 140 that overlaps the storage electrode 135. In addition, a first connecting portion 195 and a second connecting portion 196 are integrally formed. Particularly, the first connecting portion 195 is formed to extend along one side surface of the sacrificial layer 300 and one side surface of the protruding portion 35. Since pixel conductors including the pixel electrode 191, the first and second connecting portions 195 and 196, and the extension 197 are formed using the first insulating layer 180a as a mask, the first insulating layer 180a may completely overlap the pixel conductors.

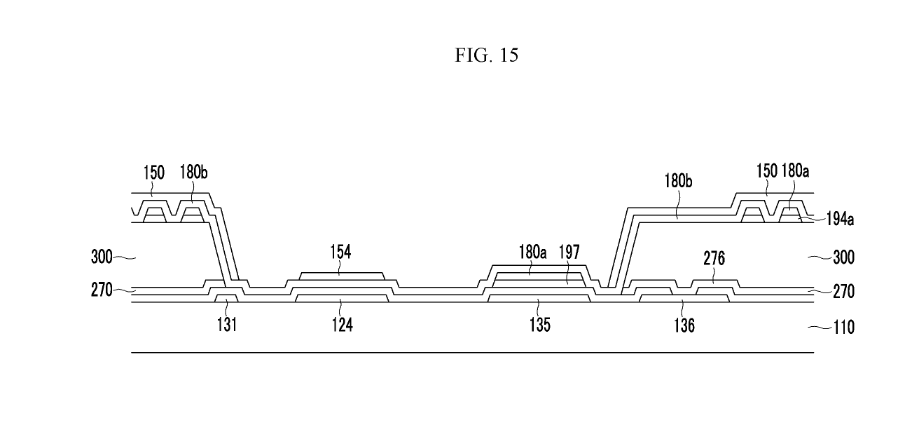

Referring to FIGS. 15, 16, and 17, a second insulating layer 180b is formed of an inorganic material such as a silicon nitride film or a silicon oxide film. A semiconductor layer 150 and a semiconductor 154 are formed on the second insulating layer 180b by the photolithography process. In this case, the semiconductor layer 150 is formed to cover the sacrificial layer 300 and the protruding portion 35 on the second insulating layer 180b, and the semiconductor 154 is formed to overlap the gate electrode 124.

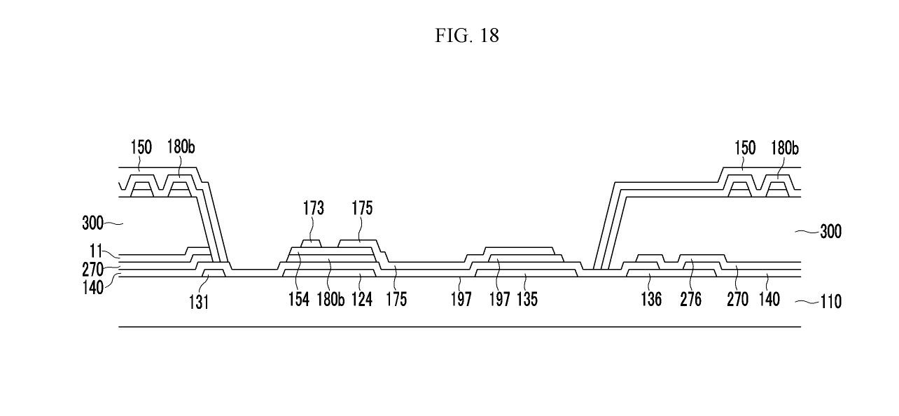

Referring to FIGS. 18, 19, and 20, a portion of the second insulating layer 180b not covered by the semiconductor layer 150 and the semiconductor 154 is etched using the semiconductor layer 150 and the semiconductor 154 as a mask. As a result, the portion of the second insulating layer 180b covering the extension 197 of the pixel electrode is removed to expose the extension 197. Subsequently, data conductors including a data line 171, a source electrode 173, and a drain electrode 175 are formed.

The data line 171 is formed to extend along one side surface of the sacrificial layer 300 and one side surface of the protruding portion 35. Since the sacrificial layer 300 and the protruding portion 35 are covered by the second insulating layer 180b and the semiconductor layer 150, the semiconductor layer 150 and the second insulating layer 180b may be disposed between the data line 171 and sacrificial layer 300 and the protruding portion 35. When the first connecting portion 195 of the aforementioned pixel electrode 191 is formed along a right side surface of the sacrificial layer 300 and a left side surface of the protruding portion 35, the data line 171 may be formed along a left side surface of the sacrificial layer 300 and a right side surface of the protruding portion 35.

The source electrode 173 and the drain electrode 175 form a thin film transistor Q along with the semiconductor 154 and the gate electrode 124 that are previously formed, and a channel of the thin film transistor Q is formed in the semiconductor 154 between the source electrode 173 and the drain electrode 175. The drain electrode 175 is formed to extend from the thin film transistor Q to above the extension 197, and is physically and electrically connected to the extension 197.

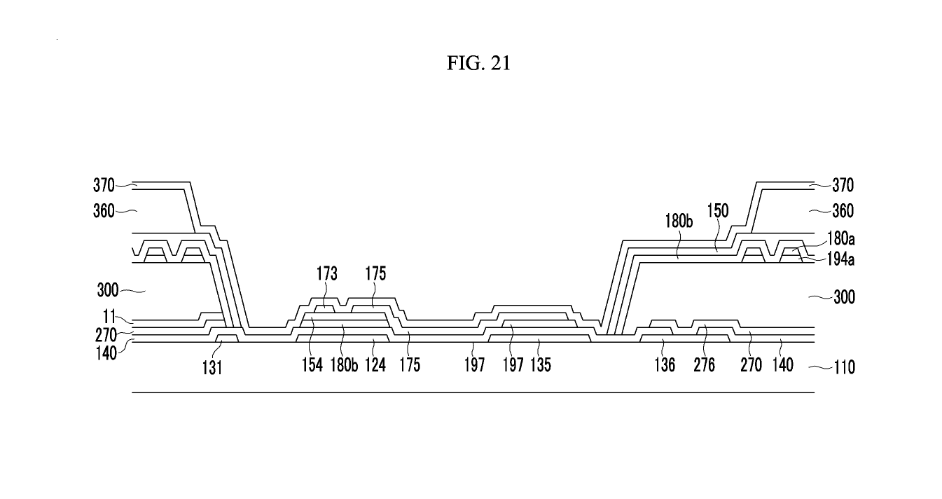

Referring to FIGS. 21, 22, and 23, an organic material is coated on the semiconductor layer 150, and a roof layer 360 is formed by a photolithography process. The roof layer 360 may be formed to be connected to the first region A1 in a row direction and to be separated therefrom in a column direction. The roof layer 360 forms a partition wall 320, which partitions the microcavity 305 to be formed by removing the sacrificial layer 300, between the sacrificial layers 300 adjacent in the row direction. The roof layer 360 may be formed as a color filter. Since the sacrificial layer 300 and the protruding portion 35 are covered by the second insulating layer 180b and the semiconductor layer 150, the sacrificial layer 300 and the protruding portion 35 may not be removed even if an etchant with low selectivity is used for the sacrificial layer 300 and the protruding portion 35 when forming the roof layer 360. After forming the roof layer 360, an upper insulating layer 370 may be formed thereon using an inorganic material such as a silicon nitride or a silicon oxide.

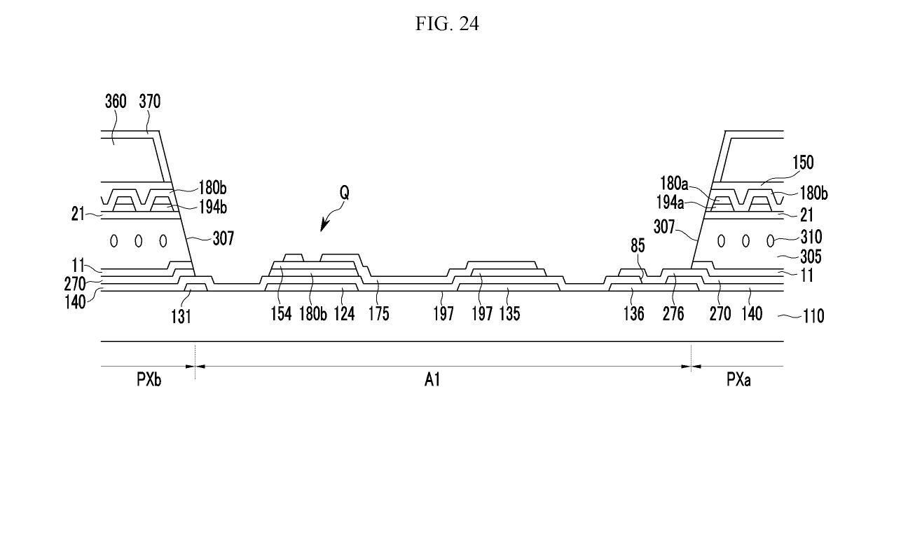

Referring to FIGS. 24, 25, and 26, the sacrificial layer 300 is partially exposed to the outside by removing the upper insulating layer 370 covering the sacrificial layer in the first region A1, and the sacrificial layer 300 is removed by an O₂ ashing process or a wet etching method. In this case, the microcavity 305 having an inlet 307 is formed. In order for the microcavity 305 to maintain its shape, a process of curing the roof layer 360 by heating may be performed.

Alignment layers 11 and 21 are formed above the common electrode 270 and below the pixel electrode 191 by injecting an aligning material through the inlet 307 into the microcavity 305 that is formed by removing the sacrificial layer 300. Specifically, when an aligning agent containing an aligning material is dripped on the substrate 110 by a spin coating method or an inkjet method, the aligning agent is injected into the microcavity 305 through the inlet 307. Subsequently, when a curing process is performed, a solution component is evaporated and the aligning material remains on an inner wall surface of the microcavity 305 to form the alignment layers 11 and 21. Next, an LC material including LC molecules 310 is injected through the inlet 307 into the microcavity 305 using an inkjet method or the like, so an LC layer filling the inside of the microcavity 305 is formed. Subsequently, an encapsulation layer 390 is formed in the first region A1 to cover the inlet 307 and a barrier layer 395 is formed across an entire surface of the substrate 110 on the encapsulation layer 390, so an LCD as illustrated in FIGS. 2 to 5 may be manufactured.

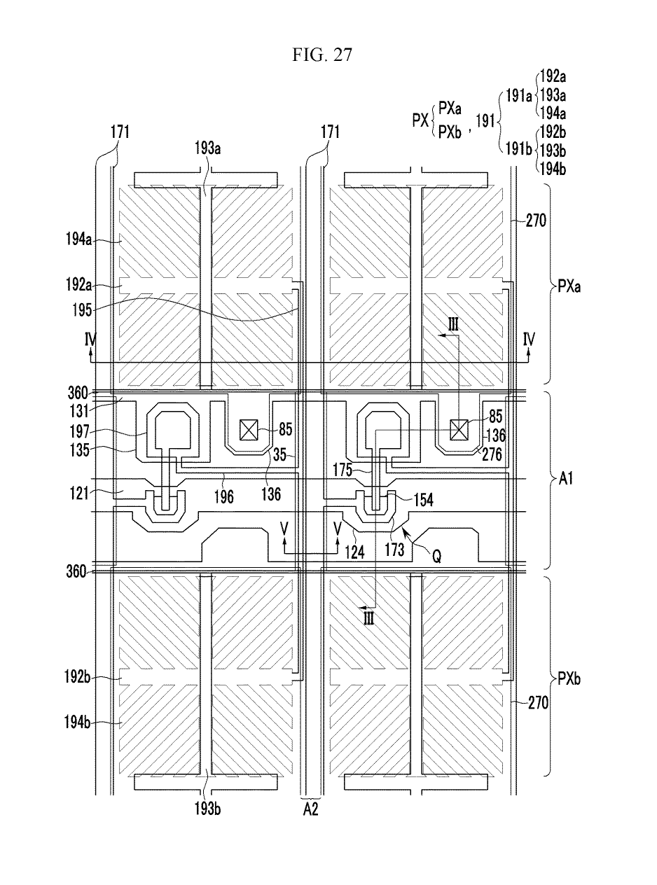

Exemplary variations of the data line 171 and the first connecting portion 195 of the pixel electrode of the inventive concept will now be described with reference to FIGS. 27 to 32.

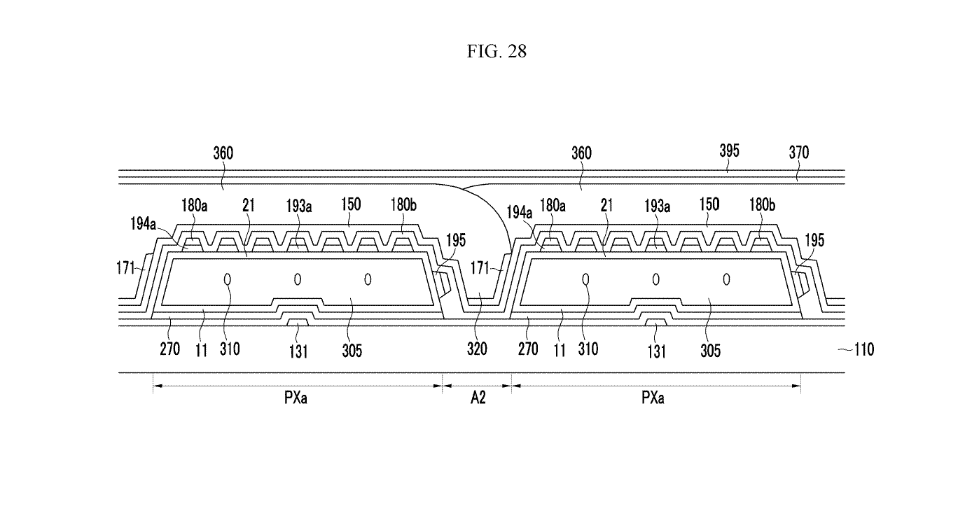

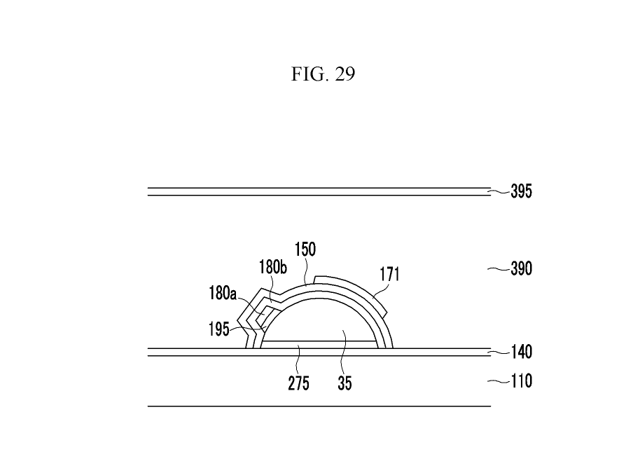

FIG. 27 is a layout view of two pixel areas in an LCD according to an exemplary embodiment, FIG. 28 is a cross-sectional view of FIG. 27 taken along the line IV-IV, and FIG. 29 is a cross-sectional view of FIG. 27 taken along the line V-V.

Referring first to FIGS. 27, 28, and 29, a data line 171 extends along a side surface of a microcavity 305 and a region substantially parallel to a planar surface of a substrate 110 between adjacent microcavities 305. Accordingly, the data line 171 extends along a bottom surface of a partition wall 320 as well as a side surface of the partition wall 320, and includes a portion extending to be inclined with the planar surface of the substrate 110 and a portion extending to be substantially parallel thereto. The data line 171 may be in contact with one side surface and the bottom surface of the partition wall 320. In a first region A1, the data line 171 extends adjacent to or beyond a substantially center portion of the protruding portion 35 in a row direction along side and top surfaces of the protruding portion 35. When the data line 171 is formed as such, a width of the data line 171 increases, so a distance between the data line 171 and a first connecting portion 195 becomes closer. However, since the width of the data line 171 can be increased while decreasing a distance between pixels, resolution can be increased and resistance of the data line 171 can be decreased.

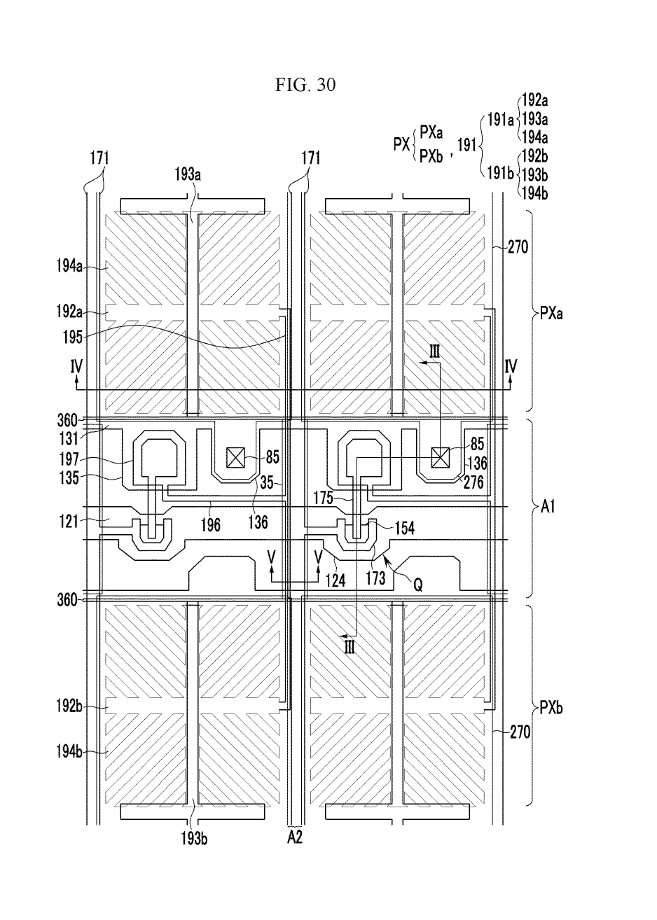

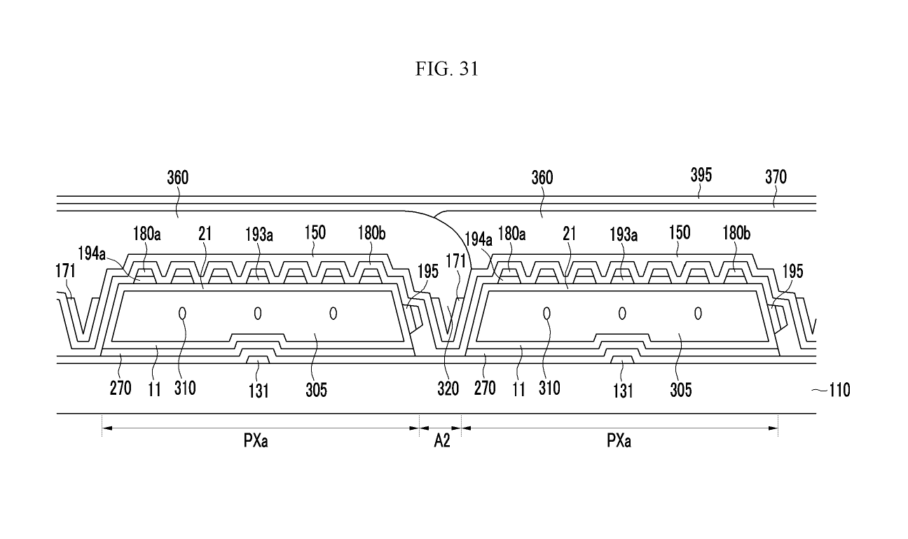

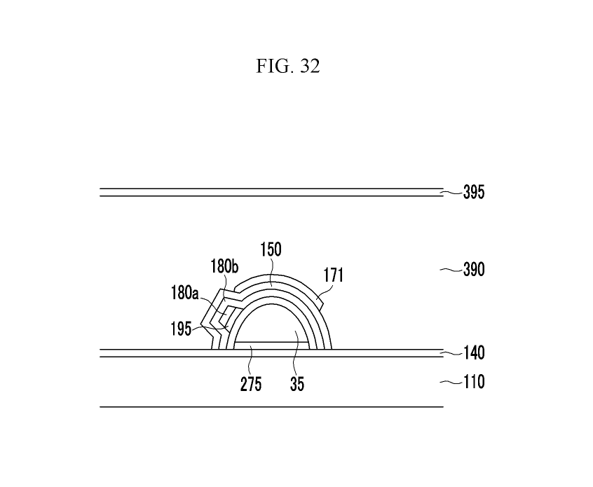

FIG. 30 is a layout view of two pixel areas in an LCD according to an exemplary embodiment of the inventive concept, FIG. 31 is a cross-sectional view of FIG. 30 taken along the line IV-IV, and FIG. 32 is a cross-sectional view of FIG. 30 taken along the line V-V.

Referring to FIGS. 30, 31, and 32, a data line 171 extends along the side surfaces of adjacent microcavities 305 that face each other. Accordingly, the data line 171 may, as shown in FIG. 29, substantially have a V-shape in a cross-sectional view passing through the microcavity 305 in a row direction. In a first region A1, the data line 171 extends beyond a substantially center portion of a protruding portion 35 in the row direction, and extends along a top surface of the protruding portion 35 while overlapping a first connecting portion 195. When the data line 171 is formed as such, a distance between adjacent pixels and a width of the partition wall 320 can be further decreased while the width of the data line 171 is maintained as is or increased further than that of the exemplary embodiment of FIG. 4 and FIG. 5. Even if the data line 171 and the first connecting portion 195 overlap each other, since the first insulating layer 180a, the second insulating layer 180b, and the semiconductor layer 150 are disposed between them, a distance between them can be maintained by thicknesses of the first insulating layer 180a, the second insulating layer 180b, and the semiconductor layer 150.

While this inventive concept has been described in connection with what is presently considered to be practical exemplary embodiments, it is to be understood that the inventive concept is not limited to the disclosed embodiments, but, on the contrary, is intended to cover various modifications and equivalent arrangements included within the spirit and scope of the appended claims.

What is claimed is:

1. A liquid crystal display (LCD) comprising:
a substrate;
a plurality of thin film transistors disposed on the substrate;
a plurality of liquid crystal (LC) layers disposed within a plurality of microcavities on the substrate;
a partition wall disposed between the LC layers adjacent in a first direction; and
a signal line disposed between the LC layers and the partition wall and connected to the plurality of thin film transistors.

2. The LCD of claim 1, wherein the signal line extends in a second direction along one side surface of one of the LC layers.

3. The LCD of claim 2, further comprising a semiconductor layer disposed between the LC layers and the signal line.

4. The LCD of claim 2, further comprising a protruding portion disposed between the LC layers adjacent in the second direction, wherein the signal line extends along one side surface of the protruding portion in the second direction.

5. The LCD of claim 4, further comprising a common electrode disposed between the substrate and the LC layers, and a pixel electrode disposed on the LC layers.

6. The LCD of claim 5, further comprising a connecting portion connecting the pixel electrode and one of the plurality of thin film transistors, wherein the connecting portion extends along the other side surface of the one of the LC layers in the second direction.

7. The LCD of claim 6, wherein the connecting portion extends along the other side surface of the protruding portion in the second direction.

8. The LCD of claim 7, wherein the signal line and the connecting portion do not overlap in a plan view.

9. The LCD of claim 7, wherein the signal line and the connecting portion at least partially overlap in a plan view.

10. The LCD of claim 5, further comprising an insulating layer disposed on the pixel electrode, wherein the pixel electrode and the insulating layer have the same planar shape.

11. The LCD of claim 5, wherein the common electrode is divided to correspond to the plurality of LC layers.

12. The LCD of claim 11, further comprising a dummy layer disposed between the substrate and the protruding portion, wherein the common electrode is connected to the dummy layer.

13. The LCD of claim 11, further comprising a storage electrode line disposed on the substrate, wherein the common electrode is electrically connected to the storage electrode line.

14. The LCD of claim 13, further comprising a gate insulating layer disposed between the storage electrode line and the common electrode, wherein the common electrode is connected to the storage electrode line through a contact hole formed in the gate insulating layer.

15. The LCD of claim 2, wherein the signal line extends along the one side surface of the one of the LC layers and along a bottom surface of the partition wall in the second direction.

16. The LCD of claim 1, further comprising a roof layer disposed on the plurality of LC layers, wherein the partition wall is a part of the roof layer that is disposed between the LC layers adjacent in the first direction.
